(19) United States
(12) Patent Application Publication
(10) Pub. No.: US 2017/0280747 A1
(43) Pub. Date: Oct. 5, 2017

(54) HEALTHY NON DAIRY TREAT FOR PETS

(71) Applicant: Patricia A. Clipper, Hollywood, CA (US)

(72) Inventor: Patricia A. Clipper, Hollywood, CA (US)

(21) Appl. No.: 15/476,858

(22) Filed: Mar. 31, 2017

Related U.S. Application Data
(60) Provisional application No. 62/317,484, filed on Apr. 1, 2016.

(51) Int. Cl. A23K 40/00; A23K 20/10; A23K 10/30; A23K 20/147; A23K 50/20; A23K 50/40

(52) U.S. Cl. CPC A23K 40/00; A23K 50/20; A23K 50/40; A23K 10/30; A23K 20/147; A23K 20/10

(57) ABSTRACT

The present invention provides plant based food compositions that are effective in creating a creamy consistency, non-dairy, plant based, frozen desert treat for animals that is comparable to dairy based ice cream. The product is a dry preparation that is in a shelf stable, dry powder form. For consumption, composition is rehydrated and blended to form an emulsion. Emulsion is placed in freezer safe container and in temperature below 32 degrees Fahrenheit. Product is served frozen, similar to the way dairy based ice cream is served.

### 1. FIELD OF THE INVENTION

The present invention relates generally to healthy plant based pet food, particularly pet treats. Product invention is sold as a pre-mixed dry form composition of plant based ingredients. Pet owner reconstitutes dry composition with only liquid (or) liquid & coconut oil and serves it frozen. If pet owner chooses packaging that does not include coconut oil, pet owner can use coconut oil blended with other plant based oil such as olive oil.

### 2. BRIEF DESCRIPTION OF DRAWINGS/PHOTOS

FIG. 1 shows the dry composition of the current invention, prior to the coconut oil being added. You can see the whole chia, flaxseeds and hulled hemp seeds. The composition is in dry form.

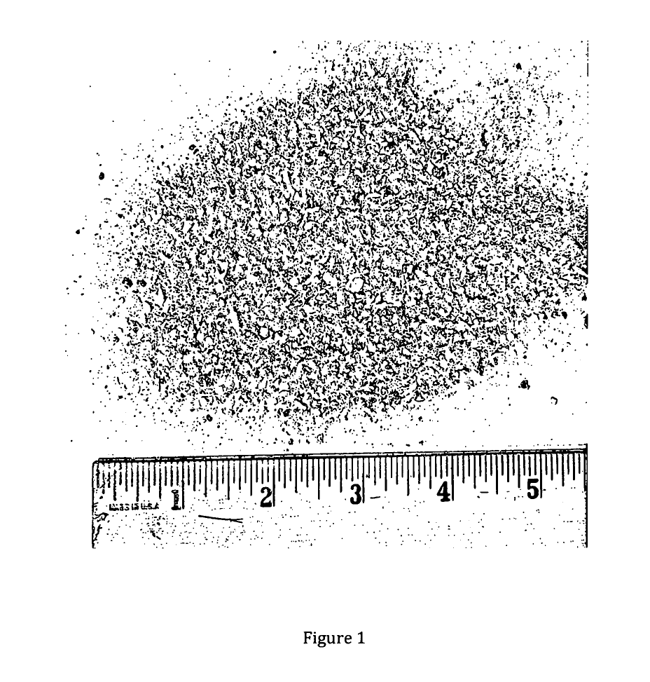

FIG. 2 shows the dry composition of the current invention with fat coconut oil on top. The center globule is coconut oil that is to be mixed into the dry composition. The composition can be packaged with or without the addition of the coconut oil.

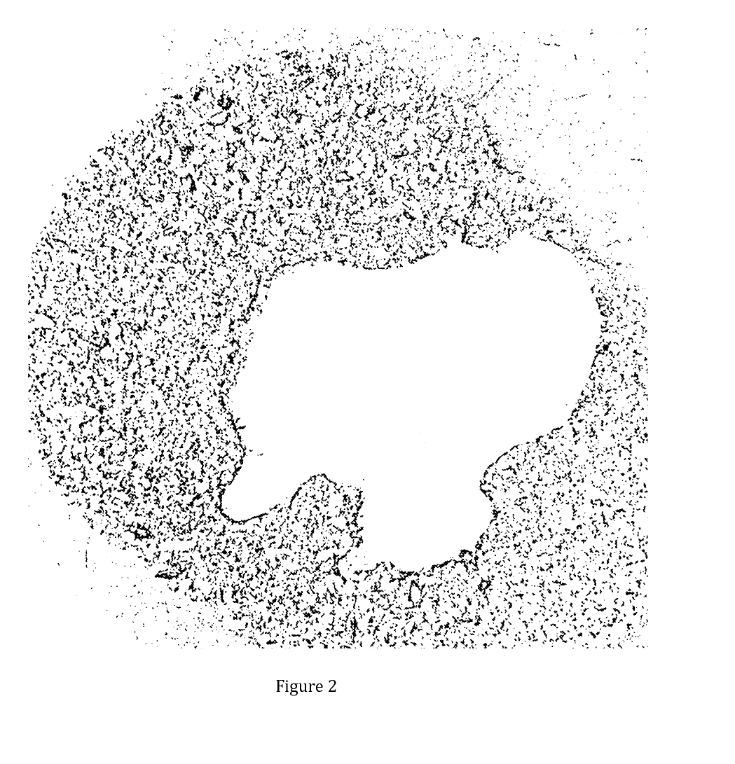

FIG. 3 shows the dry preparation fully mixed with coconut oil. This version of the composition of the current invention comes with the coconut oil already premixed and is ready to be mixed with liquid by the pet owner.

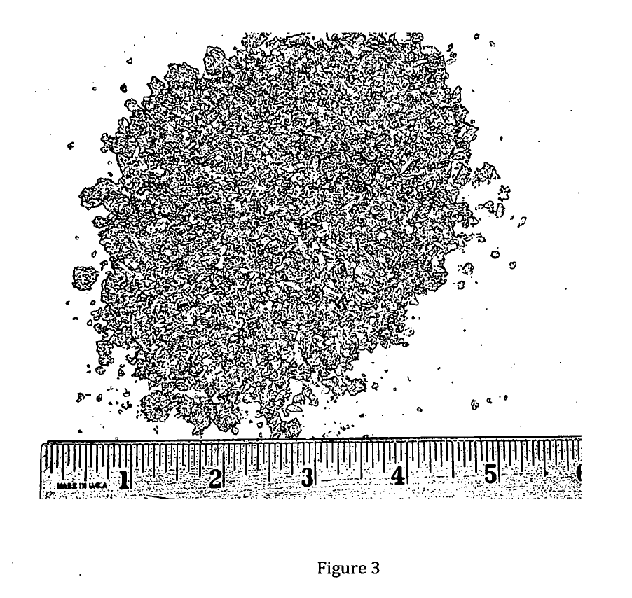

FIG. 4 shows what the preparation looks like after the composition (including oil) is reconstituted with liquid, such as water, and blended.

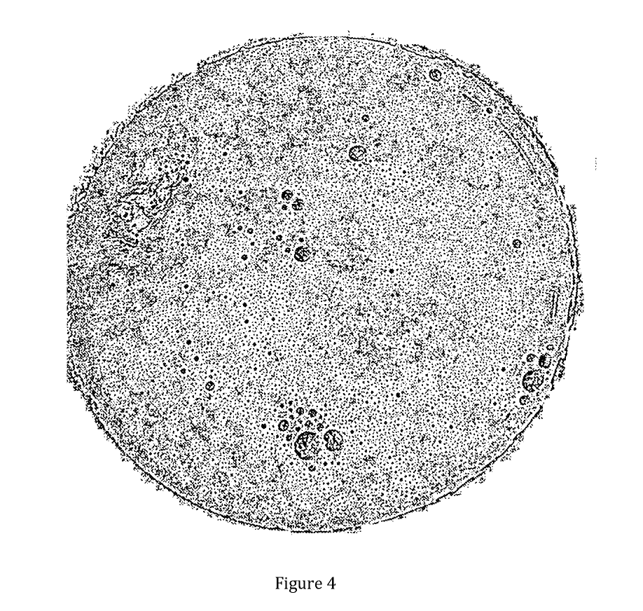

FIG. 5 shows close up view of what the preparation looks like after the composition, including oil, is reconstituted with water and blended.

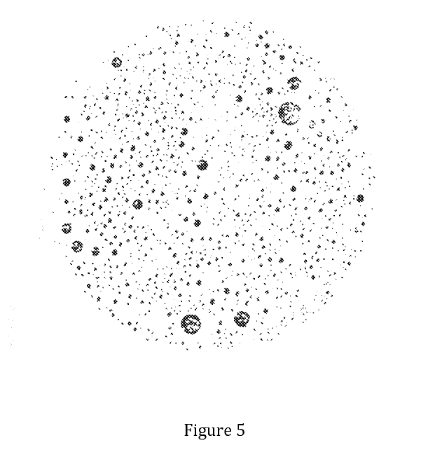

FIG. 6 shows what the preparation looks like when the composition is ready for consumption in frozen form. This is when composition had been frozen in conical shaped freezer mold.

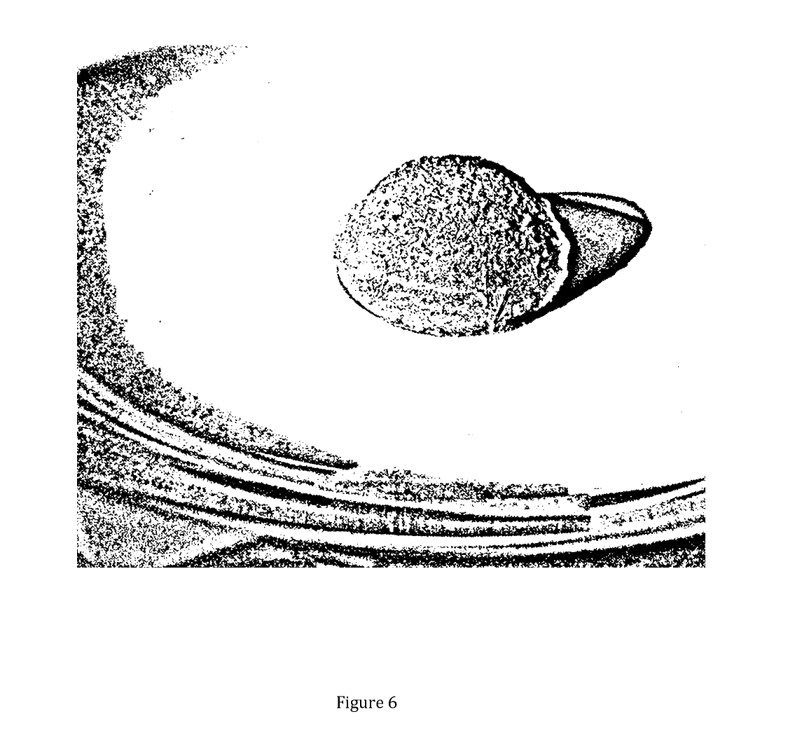

FIG. 7 shows what the preparation looks like when the composition is ready for consumption in frozen form. This is when composition had been frozen in conical and cube shaped freezer safe molds.

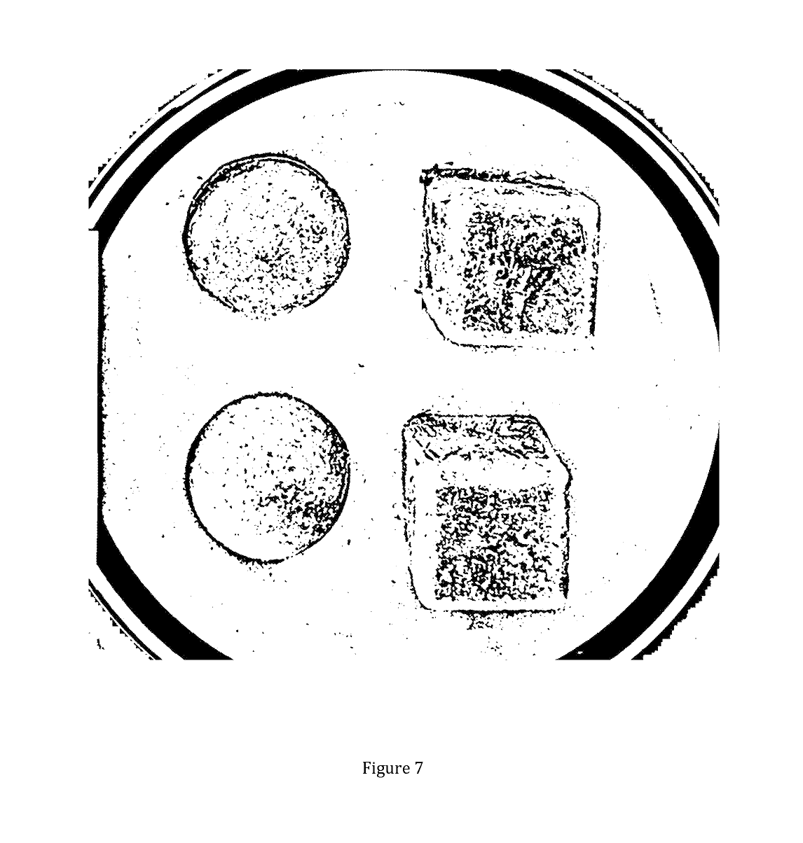

FIG. 8 shows what the preparation looks like after the composition is melting after being placed in temperature higher than 32 degrees Fahrenheit

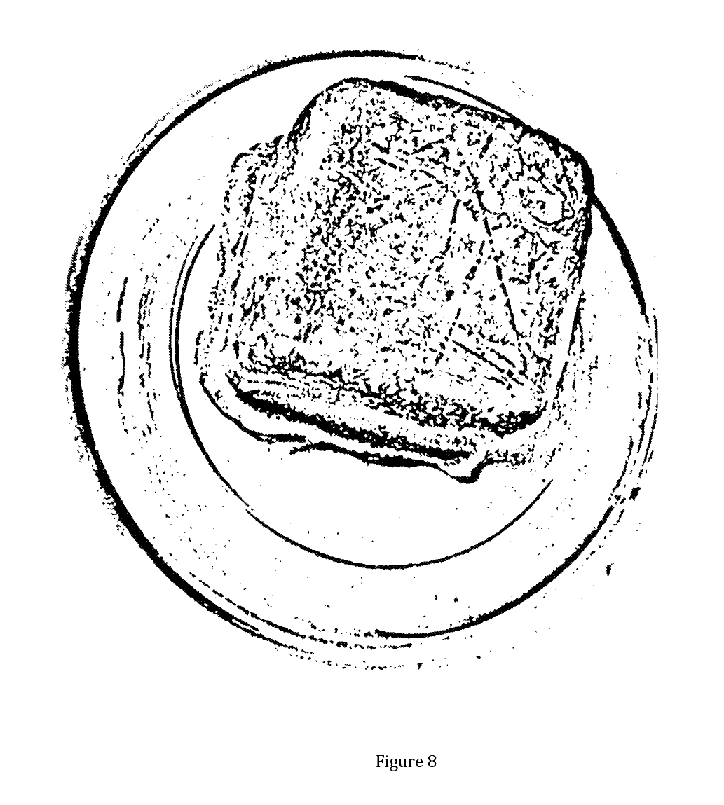

### 3. SUMMARY OF THE INVENTION

It is a well-known fact that pets, particularly canines and equines, like to eat a lot of foods that humans eat. To most pet owners, their pet is not just an animal. Instead, the pet is a beloved family member. Because of this, they allow the pet to have “treats” designed for human consumption. Like humans, the pet owner recognizes that their pets enjoy having cold treats on hot days. As a result, most pet owners give their pets dairy based ice cream as a treat of choice on a hot day. Unfortunately, the majority of canines and felines experience acute intestinal distress symptoms like gas, diarrhea or vomiting, whenever they consume dairy based foods. In order for a canine or feline to digest dairy milk, the lactose (milk sugar) must first be broken apart into two basic, easy-to-absorb sugars. In order for that to happen, the animal's body must be able to produce a special lactose-splitting enzyme known as lactase. Due to the fact that most canines, felines and equines cannot produce lactase, the animal is unable to digest dairy products. This inability to digest dairy products shows up as acute intestinal distress symptoms. This distress can cause the pet owner to bear a financial burden when helping to ease the intestinal distress symptoms of the animal.

A lot of pet treats in the market are made with artificial additives, soy, dairy milk, whey protein, eggs, grains, stabilizers, gums, glutinous substances and preservatives that are not healthy for the digestive tract of the animal, particularly canines and equines. The present invention is a composition of plant-based ingredients that are nutritious and beneficial to the digestive tract of felines, canines and equines.

The current products sold and marketed as “pet ice cream” use a dairy based ingredient in the product base. These products also have water as an ingredient. Therefore, they usually have some form of man-made preservative to prevent the bacterial growth and/or must be kept in a frozen state below 32 degrees Fahrenheit. Products that are marketed towards pets as having “no milk” or “lactose free”, commonly use a protein derived from animal milk called “Whey” protein. Whey protein has been known to cause excessive gas and bloating in canines. A sealed, moisture free, oxygen free, plant based, dried or dehydrated preparation, made from tasty whole foods, oils, spices and supplements with natural preservatives such as cinnamon, clove and/or rosemary allows the product invention to be shelf stable in ambient temperature and allows the pet owner the option of the liquid base to use based on what will be best for their pet to consume such as water, nut milk, seed milk, tree water, grain milk, legume milk, fruit juice, vegetable juice, herbal tea or any plant or animal based liquid they desire for reconstitution without the need for artificial additives, artificial preservatives and/or freezer storage from purchase to consumption. What is meant by tree water is water such as coconut water, birch water, maple water or any other water derived from trees or their fruits. What is meant by grain milk is milk such as oat milk, rice milk, barley milk, spelt milk or any other milk derived from grains. What is meant by legume milk is milk such as pea milk, soy milk, peanut milk, lupin milk or any other milk derived from legumes. What is meant by seed milk is milk such as quinoa milk, hemp milk, chia seed milk, flaxseed milk, sesame seed milk, sunflower seed milk, coconut milk or any other milk derived from seeds. What is meant by nut milk is almond milk, cashew milk, macadamia milk, pecan milk, hazelnut milk, pistachio milk, walnut milk or any other milk derived from nuts. What is meant by animal milk is milk such as cow milk, horse milk, goat milk or any other milk derived from animals. The dry product invention offers a very healthy alternative to dairy based ice cream for pets in a shelf stable dry form.

It is a known fact that canines really like the taste of peanut butter. However, peanuts contain the toxin, aflatoxin. These are naturally occurring mycotoxins that are produced by a fungus called Aspergillus. Mycotoxins are very carcinogenic (cancer-causing) and they've also been shown to be toxic to the liver. Aflatoxin is known to cause liver cancer in laboratory animals. Therefore, sunflower seeds or other fat based seeds or nuts are used instead of peanuts. This makes the product a healthy alternative. The seeds add a healthy fat and aids in the emulsification process.

Ice cream must be kept frozen to keep its integrity and to keep it from becoming a breeding ground for micro-organisms that cause food-borne illnesses. Dairy based ice cream was named as one of the top 10 sources of food poisoning in one US study. Plant based dry powder mixed with plant based food grade oil, enclosed in oxygen free and moisture free packaging, eliminates the risk of becoming a breeding ground for said micro-organisms. The dried dehydrated product is easier and less costly to transport. It lessens the carbon footprint by not needing cold storage or cold transportation due to the absence of a heavy liquid such as water. This saves on energy and fossil fuel. The current invention can be packaged with or without the added coconut oil blended directly into the finished packaged composition.

Most people don't use their freezer space for pet treats to be stored for long periods of time. Thus, having a shelf stable composition that can be made as needed becomes a convenience that is not afforded when a product is purchased frozen and must stay frozen until ready to consume. This gives the pet owner the flexibility to be able to travel with the packaged invention without the worry of spoilage. This is also convenient and cost effective for a Pet Care facility or Food Service establishment that serves food to animals.

To make creamy dairy based ice cream at home requires the use of an ice cream maker that pushes air into the mixture as it turns. Most households have blenders but an ice cream maker is not a staple item in the home. Having a product that is shelf stable and uses a blender to help get the air into the product, bypassing the need for an expensive ice cream maker, makes it cost effective, convenient and easy to create a healthy frozen pet treat.

A big problem with canines and equines is the fact that their skin can get dry and itchy and their coat can get dull if their fat levels are too low. In canines, other problems that can develop include a diminished immune system and other potential health problems such as heart disease and diabetes. Pet owners usually add oil to pet food to help ward off the issues associated with the lack of sufficient fat in the animal's diet. Adding oil to the pet food can get a bit messy if it is not emulsified in the food. Adding healthy plant based ingredients such as coconut oil, flaxseed, hemp seed, Sacha Inchi and/or sunflower seed gives the invention good healthy fats that can aid the animal/pet in having a healthier treat that can be beneficial to both the skin and coat of the animal. Coconut oil is high in Medium Chain Fatty Acids and is known to be more absorbable in the gut of the animal. Flaxseed, Hempseed and Sacha Inchi are high in Omega-3 fatty acids, which are beneficial to the skin of the animal. The invention includes these beneficial oils in an easy to transport form that is shelf stable. The current invention can also be packaged without the Coconut oil blended in with the other ingredients. In this case, the pet owner can add the coconut oil or a blend of coconut oil with another plant-based oil such as Olive and/or Sunflower oil, if they prefer to use a specific brand of oil.

Other ingredients serve various purposes and functions: Chia seed adds water binding capabilities, dietary fiber, viscosity, stability, Omega 3 fatty acids and texture. Flaxseed contains both soluble and insoluble fibers. Flaxseed is whole in the current invention's composition until the pet owner reconstitutes and blends it for use, thereby crushing and opening the seed to allow the essential fatty acid oils to be dispersed. This keeps the volatile flax oil from going rancid before use. Flaxseed adds water binding capabilities, fiber, viscosity, Omega 3 Fatty Acids and texture. Sunflower seeds and other seeds or nuts aid in the emulsification and creamy texture of the reconstituted composition. Cinnamon, clove and/or rosemary are used as a natural preservative and flavor. Lecithin aids emulsification and is a release agent. Sacha Inchi, Hemp protein and Pea protein aid emulsification as well as adding protein to the composition and diet. Coconut aids emulsification, adds fatty acids, viscosity, texture, fiber and aids binding capabilities and allows product to harden quicker (below 76 degrees Fahrenheit) and aids in the cohesive melt factor once placed in temperatures above 76 degrees Fahrenheit. This allows the pet owner or pet service provider to require less time in getting the current invention to the point where it can be served for consumption. Some of the additional ingredients add fiber, texture, taste and nutritional value to the composition. Pet owners, pet care facilities and Food Service establishments can benefit from the ease of use, storage capabilities and short time needed to produce the consumable product.

There are many advantages to having a healthy treat that is sold in a shelf stable, pre-mixed, dehydrated form that can be stored for an extended period of time. Most pet owners actually enjoy making a special treat for their pet. Once purchased, the current invention is easily reconstituted, blended in an electric blender and poured into a freezer safe container or mold and frozen. The current invention is then served frozen for consumption by the animal in the same manner as “ice cream” would be served.

This invention provides a food component environment and processing environment that minimizes the potential for microbial growth that occurs when liquid is introduced in initial packaging of food that is to be served frozen, similar to “ice cream”.

The present invention features packaging and distributing the pet food product in a plurality of natural flavors, including vanilla, mint, banana, nut butter, pumpkin, spice, Aronia berry, Elderberry, Cranberry, Maqui berry, carob, apple, sweet potato and tea flavors.

### DETAILED DESCRIPTION OF THE INVENTION

Composition: A pet food product is provided, according to the present invention, comprised of a composition of one or more of the following ingredients: Coconut flour, dried coconut, coconut oil, dried vegetables, dried fruit, hulled hemp seeds, hulled sunflower seeds, molasses, whole flaxseed, herbs and/or spices, plant based protein, chia seed, lecithin, natural preservative, aloe, herbal tea, carob.

Prepare fruits and vegetables: 1) Wash, peel and slice fruits and vegetables; 2) Bake fruits and vegetables on low temperature at approximately 160-180 degrees Fahrenheit until completely dried and dehydrated; 3) Grind dehydrated/dried fruits and vegetables into powder form.

Alternative preparation for fruits and vegetables: 1) Wash and peel fruits and vegetables; 2) Steam fruits and vegetables for 4 minutes (or) blanch for 3 minutes; 3) Place fruits and vegetables in cold water; 4) Puree fruits and vegetables; 5) Dehydrate on low temperature at approximately 130-180 degrees Fahrenheit until completely dried and dehydrated; 6) Grind dehydrated/dried fruits and vegetables into powder form.

Prepare dried shredded coconut: 1) Pierce coconut and drain juice/water; 2) Place coconut on baking sheet in oven for 20 minutes at 350 degrees Fahrenheit; 3) Crack coconut open and remove white coconut flesh from shell. 4) Remove brown skin from white meat; 5) Wash coconut meat thoroughly; 6) Shred coconut meat; 7) Bake coconut meat in oven on low temperature at approximately 250 degrees Fahrenheit for 5-15 minutes until dried and dehydrated.

Prepare Coconut flour/Molasses mixture: 1) Blend 1 cup shredded dried coconut with 1 cup water on high speed for 2 minutes; 2) Pour coconut/water mixture through super fine mesh to strain off liquid from coconut pulp solids (flour); 3) Place coconut pulp solids (flour) on baking pan and dehydrate in oven, bake at 200 degrees Fahrenheit until dry; 4) Grind dried coconut pulp solids (flour) into powder form; 5) Blend 20 ml Molasses (add 2.5-5 ml vanilla extract with molasses if making vanilla flavored mixture) and 1 cup dried coconut powder (flour) until completely blended; 6) Bake flour/molasses mixture for approximately 10 minutes at 160-180 degrees Fahrenheit or until mixture is completely dry. Alternately, an herbal tea extract or other natural plant extract can be used in the place where the vanilla extract is used for this composition.

Prepare herbs and spices: 1) Wash herbs and spices; 2) Blot with towel to remove excess water; 3) Dehydrate herbs and spices for 2 to 4 hours at 115-125 degrees Fahrenheit, until completely dried and dehydrated; 4) Grind dried herbs and spices to powder form.

Grind hulled sunflower seeds to crumble grainy consistency.

In electric blender, blend Coconut Flour/Molasses mixture, fruit and/or vegetable powder, Shredded coconut, lecithin, cinnamon, hulled sunflower seeds and Plant protein powder. In Mixer on low speed: Add the following to the blended mixture; Hulled Hemp Seeds, whole flax seeds, chia seeds. Mix until evenly dispersed. Add Coconut oil and mix until evenly dispersed. The end result is a grainy looking dry composition. Invention can also be packaged without the addition of the Coconut Oil which can be added by pet owner.

### EXAMPLES

The following examples represent various combinations of ingredients of the present invention so as to further illustrate the pet food product thereof.

### Example 1

This example sets forth the general formulation for the pet food product of the present invention.

INGREDIENTS Composition by Volume: Coconut Flour/Molasses mixture (27%-28%) Coconut oil (18%-19%) Hulled Hemp Seed (9%-10%) Dried Shredded Coconut (9%-10%) Dried Vegetable powder (18%-19%) Granulated Lecithin (4%-5%) Hulled Sunflower Seeds (4%-5%) Plant protein powder (4%-5%) Whole flax seed (2%-3%) Ground cinnamon (0.5%-1%) Whole chia seed (0.5%-1%)

### Example 2

This example sets forth an alternative formulation for the pet food product of the present invention.

INGREDIENTS Composition by Volume: Coconut Flour/Molasses mixture (24%-25%) Coconut oil (16%-17%) Hulled Hemp Seed (8%-9%) Dried Shredded Coconut (12%-13%) Dried fruit and vegetable powder (16%-18%) Granulated Lecithin (5%-6%) Hulled Sunflower Seeds (8%-9%) Plant protein powder (6%-7%) Whole flax seed (2%-3%) Ground cinnamon (0.5%-1%) Whole chia seed (0.5%-1%)

### Example 3

This example sets forth an alternative formulation for the pet food product of the present invention.

INGREDIENTS Composition by Volume: Coconut Flour/Molasses mixture (25%-28%) Coconut oil (17%-18%) Hulled Hemp Seed (8%-9%) Dried Shredded Coconut (12%-13%) Dried Vegetable and/or fruit powder (16%-18%) Granulated Lecithin (4%-5%) Hulled Sunflower Seeds (4%-5%) Plant protein powder (6%-7%) Whole flax seed (2%-3%) Ground cinnamon (0.5%-1%) Whole chia seed (0.5%-1%)

### Example 4

This example sets forth an alternative formulation for the pet food product of the present invention.

INGREDIENTS Composition by Volume: Coconut Flour/Molasses mixture (24%-26%) Coconut oil (16%-19%) Hulled Hemp Seed (8%-10%) Dried Shredded Coconut (9%-13%) Dried Vegetable and/or fruit and/or herb powder (16%-19%) Granulated Lecithin (4%-7%) Hulled Sunflower Seeds (4%-9%) Plant protein powder (4%-7%) Whole flax seed (2%-3%) cinnamon and/or clove spice (0.5%-1%) Whole chia seed (0.5%-1%), Rosemary oil extract (0.015%-0.5%)

### Example 5

This example sets forth an alternative formulation for the pet food product of the present invention without the coconut oil in finished product.

INGREDIENTS Composition by Volume: Coconut Flour/Molasses mixture (24%-25%) Hulled Hemp Seed (11%-12%) Dried Shredded Coconut (11%-12%) Dried Vegetable powder (22%-23%) Granulated Lecithin (5%-6%) Hulled Sunflower Seeds (5%-5.6%) Plant protein powder (5%-6%) Whole flax seed (2%-3%) Ground cinnamon (0.5%-1%) Whole chia seed (0.5%-1%)

### Example 6

This example sets forth an alternative formulation for the pet food product of the present invention without the coconut oil in finished product.

INGREDIENTS Composition by Volume: Coconut Flour/Molasses mixture (29%-32%) Hulled Hemp Seed (9%-10.5%) Dried Shredded Coconut (14%-15%) Dried Vegetable and/or fruit powder (19%-21%) Granulated Lecithin (5%-6.1%) Hulled Sunflower Seeds (5%-10%) Plant protein powder (7%-8%) Whole flax seed (2%-3%) cinnamon (0.25%-1%) Whole chia seed (0.5%-1%)

### Example 7

This example sets forth an alternative formulation for the pet food product of the present invention without the coconut oil in finished product.

INGREDIENTS Composition by Volume: Coconut Flour/Molasses mixture (29%-33%) Hemp Seed (9%-10.5%) Dried Shredded Coconut (14%-15%) Dried Vegetable and/or fruit and/or herb powder (19%-21%) Lecithin (5%-7%) Hulled Sunflower Seeds (5%-10%) Plant protein powder (7%-8%) Whole flax seed (2%-3%) cinnamon and/or clove spice (0.5%-1%) Whole chia seed (0.5%-1%) Rosemary oil Extract (0.015%-0.5%)

### Operation of the Preferred Embodiment

To use the present invention, the user simply reconstitutes the product with liquid, blends in electric blender, freezes product in freezer safe mold and serves the pet food product in a desired dish at room temperature as and iced cream composition similar to dairy based ice cream.

If pet owner or consumer has chosen dry product composition “without” coconut oil in the packaging, then the pet owner or consumer will simply add coconut oil AND liquid for reconstitution to blender, prior to blending, freezing and serving. The pet owner or consumer may also choose to add a blend of coconut oil AND another plant based oil along WITH liquid for reconstitution prior to blending, freezing and serving. The present invention can also come in a premixed packaged composition with Coconut and Olive oil blend in place of the straight Coconut oil.

The use of the present invention allows pets to enjoy a nutritious and tasteful food treat that can be served frozen, and which does not cause intestinal disturbances. The present invention is prepared in a manner, which is healthy, quick, easy, and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. I claim a method of using the dry pet food composition, comprising the steps of: 1) storing said pet food composition at ambient temperature for an extended time as desired; 2) pet owner reconstituting said pet food composition with liquid or liquid and oil; 3) pet owner freezing reconstituted said pet food composition in freezer safe mold or container; and 4) serving said pet food composition while frozen.

2. The process of claim 1, wherein the pet animal is a canine animal.

3. The process of claim 1, wherein the pet animal is an equine animal.

4. The process of claim 1, wherein the pet animal is a feline animal.

5. The method according to claim 1, wherein said reconstitutable dry pet food composition becomes a non-dairy frozen dessert product for pets.

6. The reconstitutable pet food of claim 1, wherein the composition is plant based ingredients.

7. A reconstitutable dry mix pet food composition comprising:
a. Coconut flour;
b. Dried coconut;
c. Dried produce;
d. Seeds selected from the group consisting of hulled sunflower seeds, hulled hemp seeds, flax seeds;
e. One or more flavorants;
f. One or more plant based proteins; and
g. Molasses

8. The composition of claim 7, wherein dried produce is comprised of vegetables, fruit, herbs and mixtures thereof.

9. The reconstitutable pet food composition of claim 7, wherein the dry mix pet food composition is reconstituted with a liquid selected from the group consisting of water, juice, plant juices, tea, nut milk, seed milk, plant based milk and mixtures thereof providing reconstituted pet food composition.

10. The reconstitutable pet food composition of claim 7, wherein the coconut flour is in the amount of about 22 to 31% vol; dried coconut is in the amount of about 11 to 15% vol; dried produce is in the amount of about 19 to 23%; seeds are in the amount of about 16 to 26% vol; flavorants are in the amount of about 1% vol; plant based proteins are in the amount of about 5 to 8% vol; Molasses is in the amount of about 1 to 3% vol.

11. The reconstitutable pet food composition of claim 7, wherein the dry mix pet food composition comprises of coconut oil in the dry composition.

12. The reconstitutable pet food composition of claim 11, wherein the coconut flour is in the amount of about 22 to 26% vol; dried coconut is in the amount of about 9 to 13% vol; dried produce is in the amount of about 16 to 19%; seeds are in the amount of about 14 to 23% vol; flavorants are in the amount of about 1% vol; plant based proteins are in the amount of about 4 to 7% vol; Molasses is in the amount of about 1 to 3% vol; coconut oil is in the amount of about 16 to 19% vol.

13. The reconstitutable pet food of claim 9, wherein the reconstituted pet food composition is frozen.

14. The reconstitutable pet food of claim 7, wherein the dry mix pet food composition comprises of lecithin at about 4 to 7% vol.
